(19) United States
(12) Patent Application Publication
(10) Pub. No.: US 2025/0132452 A1
(43) Pub. Date: Apr. 24, 2025

(54) BUTTON CELL AND ELECTRONIC DEVICE

(71) Applicant: Ningde Amperex Technology Limited, Ningde (CN)

(72) Inventors: Huimin GAO, Ningde (CN); Dongyang YAN, Ningde (CN)

(73) Assignee: Ningde Amperex Technology Limited, Ningde (CN)

(21) Appl. No.: 18/989,718

(22) Filed: Dec. 20, 2024

Related U.S. Application Data
(63) Continuation of application No. PCT/CN2022/100127, filed on Jun. 21, 2022.

(51) Int. Cl. H01M 50/342; H01M 50/109; H01M 50/533; H01M 50/536

(52) U.S. Cl. CPC H01M 50/3425; H01M 50/109; H01M 50/533; H01M 50/536

(57) ABSTRACT

A button cell includes an electrode assembly, a first electrode tab, and a housing provided with an accommodating cavity. The housing includes a first wall, a first end of the first electrode tab is connected to the electrode assembly, and a second end of the first electrode tab is connected to the first wall. The housing is provided with a groove including at least two continuously connected curves. Viewed from a direction perpendicular to the first wall, a projection of the first electrode tab on the first wall is a first projection, at least a portion of the at least two continuously connected curves is located outside the first projection, and a quantity of intersection points between a contour of the first projection and the at least two continuously connected curves is less than or equal to 2.

### CROSS REFERENCE TO RELATED APPLICATION

This application is a continuation application of International Application No. PCT/CN2022/100127, filed on Jun. 21, 2022, the contents of which are incorporated herein by reference in its entirety.

### TECHNICAL FIELD

This application relates to the field of battery technologies, and particularly to a button cell and an electronic device.

### BACKGROUND

Button cells are mostly regular cylindrical batteries packaged with metal shells. Conventional button cells need to operate in a space relatively isolated from the external environment, and have limited internal space. During use, the button cell may generate some gas, which can accumulate over time. If the gas is not effectively vented, the internal pressure of the button cell will increase, which may weaken the performance and safety of the button cell.

### SUMMARY

This application aims to provide a button cell and an electronic device with improved performance in use and safety.

Some embodiments of this application provide the following technical solutions to solve the technical problems: a button cell, including a housing, an electrode assembly, and a first electrode tab, where the housing is provided with an accommodating cavity, and the electrode assembly and the first electrode tab are both accommodated in the accommodating cavity. The housing includes a first wall, and the first electrode tab includes a first end and a second end arranged oppositely, first end being connected to the electrode assembly, and the second end being connected to the first wall. The housing is provided with a groove. Viewed from a first direction, the groove includes at least two continuously connected curves, an orthogonal projection of the first electrode tab on the first wall is a first projection, at least a portion of the at least two continuously connected curves is located outside the first projection, a quantity of intersection points between a contour of the first projection and the at least two continuously connected curves is less than or equal to 2, and the first direction is perpendicular to the first wall.

A groove is provided on the first wall of the housing, so that a thickness of a position at which the groove on the first wall is located becomes thinner. When the internal pressure of the housing increases, the groove will first be broken through by the gas inside the housing, and the broken groove may vent the gas inside the housing, which helps reduce the risk of excessive internal pressure in the button cell and improves the performance and safety of the button cell. In addition, the groove includes at least two continuously connected curves, which may increase the stress concentration points of the groove, which helps reduce the pressure required for the gas inside the housing to break through the groove, and further helps reduce the risk of excessive internal pressure in the button cell. Furthermore, button cells are generally small in size. However, to meet the design requirements of electrical performance such as rate performance, and to enhance the reliability of the connection between the first electrode tab and the housing, and to facilitate the connection between the first electrode tab and the housing during manufacturing, the first electrode tab needs to have a certain area, the first projection occupies a relatively large proportion of the first wall, and at least a portion of the two continuously connected curves is arranged outside the first projection, with a quantity of intersection points between a contour of the first projection and the at least two continuously connected curves being less than or equal to 2, which helps enhance the reliability of the groove during operation.

In some embodiments, an orthogonal projection of the groove on the first wall is a second projection, where an overlapping area of the first projection and the second projection is P, an area of the first projection is Q, and P≤Q/2. When this relationship is met, the risk of the gas generated in the accommodating cavity being blocked by the first electrode tab can be reduced, which is favorable for the gas to be able to squeeze the groove in a timely manner, and favorable for the gas in the accommodating cavity to break through the groove in a timely manner once the pressure required to break the groove is reached, thereby improving the safety of the button cell.

In some embodiments, viewed from the first direction, a junction between two adjacent curves of the at least two continuously connected curves is a connection point, and at least one of the connection points is located outside the first projection. In this way, the risk of the connection point being completely covered by the first electrode tab can be reduced, which is favorable for the gas inside the button cell to directly squeeze the connection point, so as to release the internal pressure of the button cell, thereby improving the safety of the button cell.

In some embodiments, the groove is composed of two continuously connected curves, two opposite ends of the groove are a third end and a fourth end, and the first projection intersects with the two continuously connected curves at a first intersection point and a second intersection point, where the first intersection point is closer to the third end than the second intersection point. A shortest distance from the third end to an edge of the first wall is S₁, a shortest distance from the fourth end to an edge of the first wall is S₂, a shortest distance from the first intersection point to an edge of the first wall is S₃, a shortest distance from the second intersection point to an edge of the first wall is S₄, where S₁<S₃, S₂<S₃, S₁<S₄, and S₂≤S₄. In this way, the two continuously connected curves are arranged to pass through two contour edges of the first projection, with the second projection not completely covered by the first projection, meaning that the groove is not completely covered by the first electrode tab, which is favorable for the gas in the accommodating cavity to break through the groove from the portion of the groove not covered by the first electrode tab, allowing the button cell to relieve pressure in a timely manner; and the quantity of grooves arranged can be reduced, which reduces the impact of the groove on the first wall, and ensures a better lifespan of the button cell.

In some embodiments, in the first direction, a thickness of the first wall is T₁ μm, a depth of the groove is h μm, where 0.2T₁≤h≤0.7T₁, and 30≤T₁≤300. In this way, the thickness of the first wall in a region at which the groove is located will become thinner compared to other regions of the first wall, and the region at which the groove is located is easily deformed by the gas in the accommodating cavity, which is favorable for the gas in the accommodating cavity to break through the housing from the region at which the groove is located, reduces the risk of excessive internal pressure due to gas accumulation in the button cell, and also reduces the impact of excessive thickness of the groove on the strength of the housing, thereby improving the lifespan of the button cell.

In some embodiments, in a direction perpendicular to an extending direction of the groove, the groove has a first cross section, and a shape of the first cross section is trapezoidal. In the first direction, the first cross section has a first side and a second side arranged oppositely. The first side is closer to the accommodating cavity than the second side, and a size of the first side is larger than a size of the second side. In this way, the inner side wall of the groove will form an inclined surface relative to a surface of the first wall, which is favorable for the gas in the accommodating cavity to converge toward the bottom of the groove, and is more favorable for the gas in the accommodating cavity to break through the groove, thereby reducing the risk of excessive internal pressure in the button cell.

In some embodiments, the button cell further includes a pole, an insulating member, and a second electrode tab, where the first wall and the pole are oppositely arranged in the first direction. The housing is provided with an opening. The pole and the insulating member are disposed at the opening, and the pole and the insulating member fit to close the opening. The insulating member insulates the pole from the housing. The second electrode tab includes a fifth end and a sixth end arranged oppositely. The fifth end is connected to the electrode assembly, and the sixth end is connected to the pole. IN this way, the housing may serve as an electrode of the button cell to meet the needs of different assembly environments, which facilitates the direct electrical connection between the button cell and the electronic device.

In some embodiments, the button cell further includes an insulating member and a second electrode tab. The housing includes a first housing and a second housing. The first housing is connected to the second housing, and the first housing and the second housing jointly enclose the accommodating cavity. The insulating member insulates the first housing from the second housing. The fifth end of the second electrode tab is connected to the electrode assembly, and the sixth end of the second electrode tab is connected to the second housing. The first wall is disposed on the first housing, and the first wall and the second housing are oppositely arranged in the first direction. In this way, the first housing and the second housing respectively act as positive and negative electrodes of the button cell, which helps simplify the assembly process of the button cell and also facilitates the direct electrical connection between the button cell and the electronic device.

In some embodiments, directions of two adjacent curves of the at least two continuously connected curves are the same. This helps further create larger stress concentration points, facilitates the working reliability of the grooves. In addition, this helps reduce the grooves and concentrate them within a certain range on the basis of meeting the pressure relief reliability requirements, thereby reducing the possibility of the grooves occupying a large area of the first wall and facilitating other processing of the first wall.

In some embodiments, the first electrode tab is welded to the first wall. This helps enhance the reliability of the connection between the first electrode tab and the first wall.

In some embodiments, a shape of the first wall is planar. This facilitates better consistency in the groove arranged on the first wall along an extending direction of the groove and also helps improve the consistency of the groove arranged on different first walls in mass production.

In some embodiments, the electrode assembly is a wound structure or a laminated structure.

This application further provides an electronic device, including the foregoing button cell.

The beneficial effects of some embodiments of this application are that in the button cell provided in some embodiments of this application, a groove is provided on the first wall of the housing, which means that the position of the groove on the first wall is thinned. The position of the groove is a region with a smaller thickness of the first wall. When the internal pressure of the housing increases, the groove will first be broken through by the gas inside the housing, and the broken groove may vent the gas inside the housing, which helps reduce the risk of an explosion of the button cell and improves the performance and safety of the button cell. In addition, the groove includes at least two continuously connected curves, which increases the stress concentration points of the groove, which helps reduce the pressure required for the gas inside the housing to break through the groove, and further helps reduce the risk of excessive internal pressure in the button cell.

### BRIEF DESCRIPTION OF DRAWINGS

To describe the technical solutions of some embodiments of this application more clearly, the following briefly describes the accompanying drawings for describing some embodiments of this application. Obviously, the accompanying drawings described below are merely some embodiments of this application. For those skilled in the art, other drawings can also be obtained based on these drawings.

FIG. 1 is a top view of a button cell according to one embodiment of this application;

FIG. 2 is a schematic view of one case after the button cell is cut along line A-A in FIG. 1;

FIG. 3 is a schematic view of another case after the button cell is cut along line A- A in FIG. 1;

FIG. 4 is a schematic view of an electrode assembly after the button cell is cut along line B-B in FIG. 2;

FIG. 5 is a schematic structural diagram of an orthogonal projection of a groove of the current button cell on a first wall;

FIG. 6 is a schematic structural diagram of orthogonal projections of a first electrode tab and a groove on a first wall according to one embodiment of this application;

FIG. 7 is a schematic structural diagram of orthogonal projections of a first electrode tab and a groove on a first wall according to another embodiment;

FIG. 8 is a schematic structural diagram of orthogonal projections of a first electrode tab and a groove on a first wall according to yet another embodiment;

FIG. 9 is a schematic structural diagram of orthogonal projections of a first electrode tab and a groove on a first wall according to still yet another embodiment;

FIG. 10 is a schematic diagram of the overlap of the orthogonal projections of the first electrode tab and the groove on the first wall in FIG. 8;

FIG. 11 is a schematic structural diagram of orthogonal projections of a first electrode tab and a groove on a first wall according to one embodiment of this application;

FIG. 12 is a schematic structural diagram of orthogonal projections of a first electrode tab and a groove on a first wall according to another embodiment;

FIG. 13 is a schematic structural diagram of orthogonal projections of a first electrode tab and a groove on a first wall according to yet another embodiment;

FIG. 14 is a schematic structural diagram of orthogonal projections of a first electrode tab and a groove on a first wall according to still yet another embodiment;

FIG. 15 is a schematic structural diagram of orthogonal projections of a first electrode tab and a groove on a first wall according to yet another embodiment;

FIG. 16 is a schematic structural diagram of orthogonal projections of a first electrode tab and a groove on a first wall according to still yet another embodiment;

FIG. 17 is a schematic structural diagram of orthogonal projections of a first electrode tab and a groove on a first wall according to yet another embodiment;

FIG. 18 is a schematic structural diagram of orthogonal projections of a first electrode tab and a groove on a first wall according to still yet another embodiment;

FIG. 19 is a partial schematic cross-sectional view of a first wall;

FIG. 20 is a cross-sectional view of a button cell according to yet another embodiment of this application; and

FIG. 21 is a block diagram of an electronic device according to another embodiment of this application.

In the accompanying drawings: 100: button cell; 10: housing; 20: electrode assembly; 30: first electrode tab; 40: second electrode tab; 50: insulating member; 60: pole; 31: first end; 32: second end; 41: fifth end; 42: sixth end; 101: accommodating cavity; 102: opening; 201: first electrode plate; 202: second electrode plate; 203: separator; 110: first housing; 120: second housing; 112: first wall; 114: groove; 30a: first projection; 114a: second projection; 1140: continuous curve; 1143: connection point; 1141: first curve; 1142: second curve; 311: first projection edge; 312: second projection edge; 313: third projection edge; 1140a: first portion; 1140b: second portion; 1144: third end; 1145: fourth end; 301: first intersection point; 302: second intersection point; 114b: first cross section; 114b1: first side; 114b2: second side; and 200: electronic device.

### DETAILED DESCRIPTION

For ease of understanding this application, the following makes a more detailed description of this application with reference to the accompanying drawings and specific embodiments. It should be noted that when a component is referred to as being “fixed to” or “connected to” another component, it may be directly fixed to the another component, or there may be one or more components in between. When a component is deemed as being “connected to” another component, it may be directly connected to the another component, or there may be one or more components in between. In the descriptions of this application, the orientations or positional relationships indicated by the terms “end”, “lower part”, “backward”, and the like are based on the orientations or positional relationships shown in the accompanying drawings. Such terms are intended merely for the ease and brevity of description of this application without indicating or implying that the apparatuses or components mentioned in this application must have specified orientations or must be constructed and operated in the specified orientations, and therefore shall not be construed as any limitations on this application. In addition, the terms “first”, “second”, and the like are merely intended for a purpose of description, and shall not be understood as an indication or implication of relative importance.

Unless otherwise defined, all technical and scientific terms used herein shall have the same meanings as commonly understood by those skilled in the art to which this application belongs. The terms used in the specification of this application are merely intended to describe specific embodiments but not to constitute any limitations on this application.

In addition, technical features involved in different embodiments of this application that are described below may be combined provided that they do not conflict with each other.

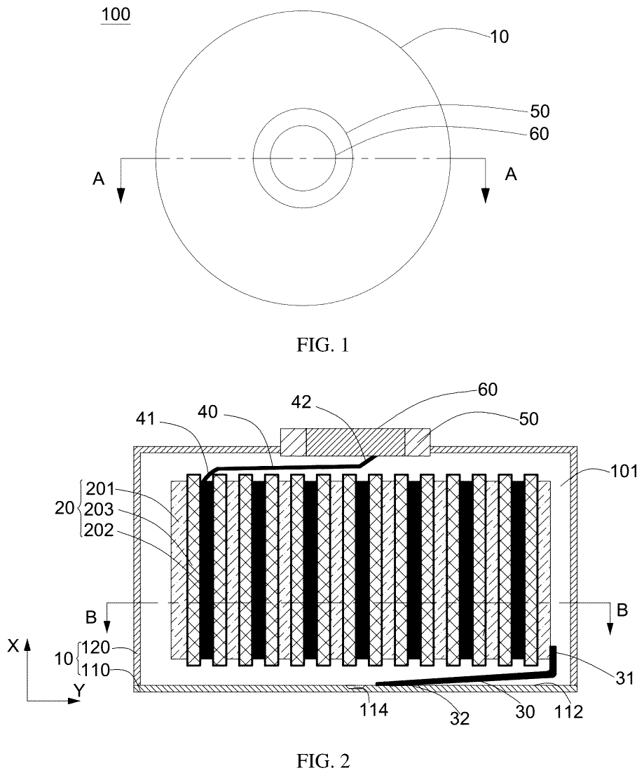

Referring to FIGS. 1 and 2, FIG. 1 is a top view of a button cell 100 according to one embodiment of this application, and FIG. 2 is a schematic view after the button cell is cut along line A-A of FIG. 1. The button cell 100 provided in this application includes a housing 10, an electrode assembly 20, and a first electrode tab 30. The housing 10 is provided with an accommodating cavity 101. The electrode assembly 20 and the first electrode tab 30 are both accommodated in the accommodating cavity 101, and the accommodating cavity 101 can be loaded with electrolyte solution (not shown in the figure). The first electrode tab 30 has a first end 31 and a second end 32, with the first end 31 and the second end 32 arranged oppositely. The first end 31 is connected to the electrode assembly 20, and the second end 32 is connected to an inner wall of the housing 10. In this way, the housing 10 may directly serve as an electrode of the button cell 100. It should be understood that although the shape of the housing 10 shown in FIGS. 1 and 2 is cylindrical, the shape of the housing 10 is not limited to the cylindrical shape shown in the figure. It may also be other shapes provided that it can load the electrode assembly 20 and the electrolyte solution.

The housing 10 is made of metal material or alloy material. In some embodiments, when the housing 10 is connected to a positive electrode, the housing 10 may be made of aluminum or aluminum alloy. The aluminum alloy housing includes element Al and also includes one or more of Mn, Cr, Ni, Co, Cu, Fe, Mg, Si, Ti, V, and Zn, which can reduce the risk of the housing 10 being corroded by the electrolyte solution. In some embodiments, when the housing 10 is connected to a negative electrode, the housing 10 may be made of steel. The steel housing includes elements Fe and C, and it may also include one or more of the elements Ni, Co, Al, Mn, Cr, Cu, Mg, Mo, S, Si, Ti, V, Pb, Sb, N, and P, which can reduce the risk of the housing 10 being corroded by the electrolyte solution. In some embodiments, when the housing 10 is made of steel, a surface of the housing 10 facing the electrode assembly 20 may be provided with a nickel (Ni) layer, which helps further reduce the risk of the housing being corroded by the electrolyte solution. In some embodiments, a surface of the housing 10 facing away from the electrode assembly 20 may be provided with a nickel (Ni) layer, which helps reduce the risk of the housing 10 being corroded by the external environment.

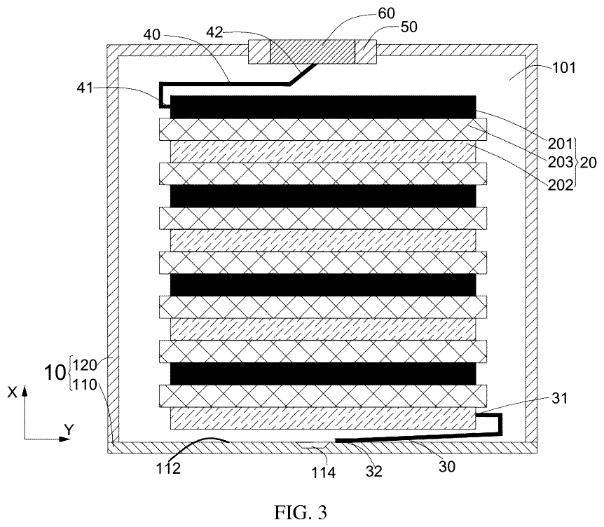

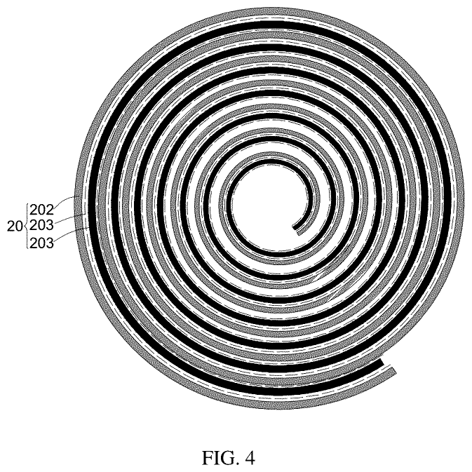

As shown in FIGS. 2 and 3, the electrode assembly 20 includes a first electrode plate 201, a second electrode plate 202, and a separator 203. The separator 203 is arranged between the first electrode plate 201 and the second electrode plate 202. The first electrode plate 201 and the second electrode plate 202 have different polarities. The separator 203 is used to reduce the risk of a short circuit between the first electrode plate 201 and the second electrode plate 202. In one method, as shown in FIGS. 2 and 4, FIG. 4 is a schematic view of the electrode assembly after the button cell is cut along line B-B in FIG. 2. The first electrode plate 201, the second electrode plate 202, and the separator 203 are stacked and wound to form a wound structure. In another method, as shown in FIG. 2 or FIG. 3, the first electrode plate 201, the second electrode plate 202, and the separator 203 each are provided in plurality. The plurality of first electrode plates 201, the plurality of second electrode plates 202, and the plurality of separators 203 are stacked along a thickness direction of the separator. In this case, a thickness direction of the electrode assembly 20 is the same as the thickness direction of the separator 203.

It should be understood that in the second case, the thickness direction of the electrode assembly 20 may be the same as or different from the thickness direction of the housing 10. For example, as shown in FIG. 2, a first direction X in FIG. 2 is used as the thickness direction of the housing 10. The thickness direction of the separator 203 is different from a thickness direction of the housing 10. In this case, the thickness direction of the separator 203 is perpendicular to the first direction X.

The first end 31 of the first electrode tab 30 may be connected to the first electrode plate 201 or the second electrode plate 202, and is specifically arranged according to actual needs. For ease of description, the following describes this application in detail using the first end 31 of the first electrode tab 30 being connected to the first electrode plate 201 as an example.

The interior of the button cell 100 needs to operate in a space relatively isolated from the external environment and has limited internal space. During use, some gas may be generated. After a period of accumulation, if the gas is not effectively vented, the internal pressure of the button cell 100 will increase, potentially weakening the performance and safety of the button cell 100, thus bringing safety hazards. For this reason, it is necessary to design relevant structures to vent the overpressure in the button cell 100 in a timely manner, so as to reduce the risk of an explosion of the button cell 100.

The button cell 100 may have different explosion-proof methods, one of which is to directly install an explosion-proof valve on the housing. The explosion-proof valve is in communication with the accommodating cavity inside the housing. However, this explosion-proof method requires an additional installation of the explosion-proof valve, which has relatively high costs.

Another method is to arrange a weak region in a portion of a surface of the housing, which means that the housing has a region with relatively thinner thickness. When the pressure reaches a certain level, the weak region may be broken to relieve pressure. The inventors of this application found that the position arrangement and structural design of the weak region in this explosion-proof method are too random, and there is a risk that the weak region is covered by the electrode tab, affecting the normal pressure relief of the button cell, thus bringing safety hazards. Based on this, the inventors of this application designed the shape of the weak region and the position arrangement between the weak region and the first electrode tab so as to improve the safety performance of the button cell. The specific solutions are as follows.

In some embodiments, as shown in FIG. 2, the housing 10 includes a first housing 110 and a second housing 120. The first housing 110 is connected to the second housing 120 to enclose the accommodating cavity 101. The first housing 110 includes a first wall 112 and a groove 114 arranged on the first wall 112. The groove 114 may be located on a side of the first wall 112 facing the electrode assembly 20, or the groove 114 may be located on a side of the first wall 112 facing away from the electrode assembly 20, specifically arranged according to actual needs. In the accompanying drawings of this embodiment, the structure of the button cell in this application is illustrated with the groove 114 located on the side of the first wall 112 facing the electrode assembly 20 as an example.

The first electrode tab 30 is connected to the first wall 112. The first electrode tab 30 and the first wall 112 may be connected through welding or using a conductive adhesive, or of course, may be electrically connected by other means.

In a direction perpendicular to a surface of the first wall 112 close to the electrode assembly 20, as the first direction X, viewed from the first direction X, an orthogonal projection of the first electrode tab 30 on the first wall 112 is a first projection 30a, and an orthogonal projection of the groove 114 on the first wall 112 is a second projection 114a. A contour of the first projection 30a is an edge contour of a projection shape of the first electrode tab 30 projected onto a surface of the first wall 112 in the first direction X. A contour of the second projection 114a is an edge contour of a projection shape of the groove 114 projected onto a surface of the first wall 112 in the first direction X.

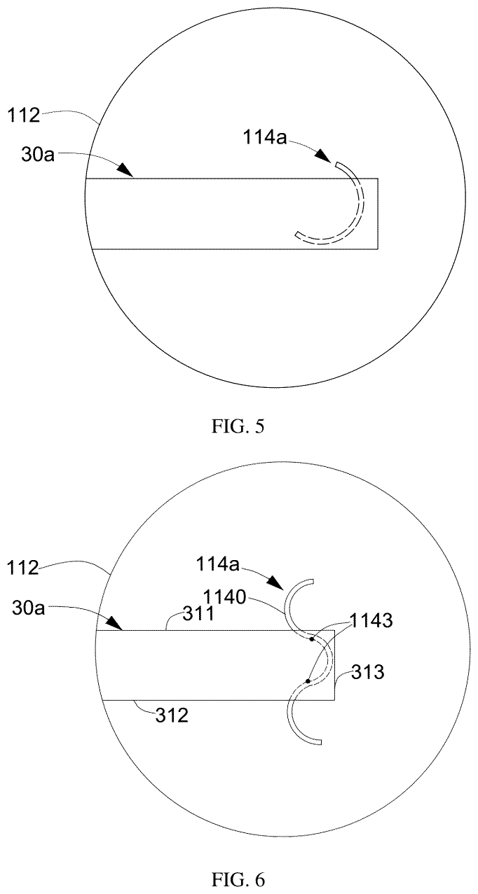

The inventors of this application found that, as shown in FIG. 5, when the groove 114 is designed as an arc groove, its orthogonal projection on the surface of the first wall 112 is a circular curve. If the position of the groove 114 is randomly arranged, there is a risk of the groove 114 being completely covered by the first electrode tab 30, and the difficulty for the gas in the accommodating cavity 101 to break through the groove 114 is increased, which is not conducive to improving the safety performance of the button cell 100, and results in insufficient stress concentration points of the groove 114. In this case, the reliability of pressure relief needs to be improved. For this reason, the inventors of this application improved the shape and position of the groove 114, designing the groove 114 to include at least two continuously connected curves, at least a portion of the two continuously connected curves is located outside the contour of the first projection 30a, and a quantity of intersection points between a contour of the first projection 30a and the at least two continuously connected curves is less than or equal to 2.

The groove 114 is provided on the first wall 112 of the housing 10, so that a thickness of a position at which the groove 114 on the first wall 112 is located on the first wall 112 becomes thinner, and when the internal pressure of the housing 10 increases, the groove 114 will first be broken through by the gas inside the housing, and the broken groove 114 may vent the gas inside the housing, which helps reduce the risk of excessive internal pressure in the button cell 100, and improves the performance and safety of the button cell 100. In addition, the groove 114 includes at least two continuously connected curves, which increases the stress concentration points of the groove 114, which helps reduce the pressure required for the gas inside the housing 10 to break through the groove 114, and further helps reduce the risk of excessive internal pressure in the button cell 100. Furthermore, button cells 100 are generally small in size. However, to meet the design requirements of electrical performance such as rate performance, and to enhance the reliability of the connection between the first electrode tab 30 and the housing 10, and to facilitate the connection between the first electrode tab 30 and the housing 10 during manufacturing, the first electrode tab 30 needs to have a certain area, the first projection 30a occupies a relatively large proportion of the first wall 112, and at least a portion of the at least two continuously connected curves is arranged outside the first projection 30a, with a quantity of intersection points between a contour of the first projection 30a and the at least two continuously connected curves being less than or equal to 2, which helps enhance the reliability of the groove 114 during operation.

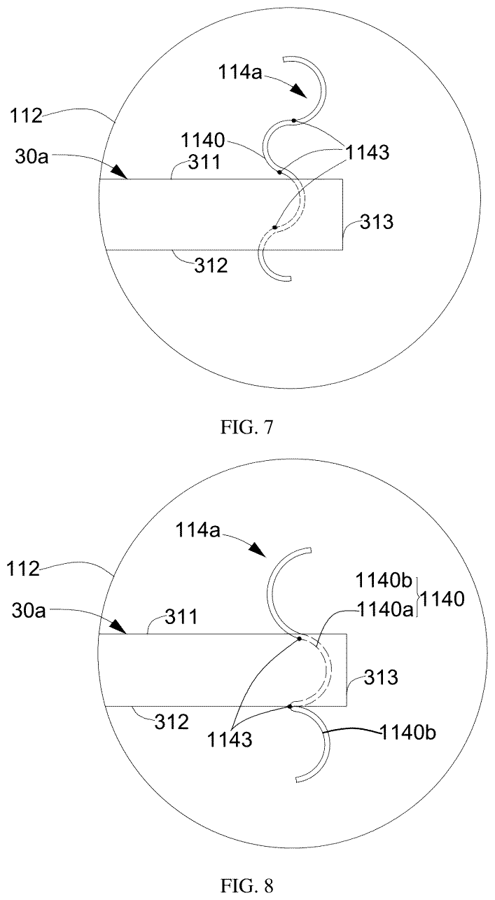

In some embodiments, as shown in FIGS. 6 to 17, viewed from the first direction X, the contour of the first projection 30a of the first electrode tab 30 on the first wall 112 has a first projection edge 311, a second projection edge 312, and a third projection edge 313, the first projection edge 311 and the second projection edge 312 are two projection edges oppositely arranged on the first projection 30a, and the third projection edge 313 connects the first projection edge 311 and the second projection edge 312.

The curve of the groove 114 described in this application refers to, viewed from the first direction X, a line of the shape of the groove 114 continuously extending on one side of a direction perpendicular to an extending direction of the groove 114. A junction between two adjacent curves of the at least two continuously connected curves is defined as a connection point. It can be understood that, the shape changes abruptly at the connection point between the two adjacent curves of the at least two continuously connected curves, which helps form stress concentration points. To be specific, the stress is more concentrated at the connection point, and this point is the weakest, which is favorable for the internal pressure of the button cell 100 to first break through the connection point and then spread to the surrounding region to form a tear so as to break through the groove 114, and facilitates the timely discharge of the gas inside the button cell 100, thereby improving the safety of the button cell 100.

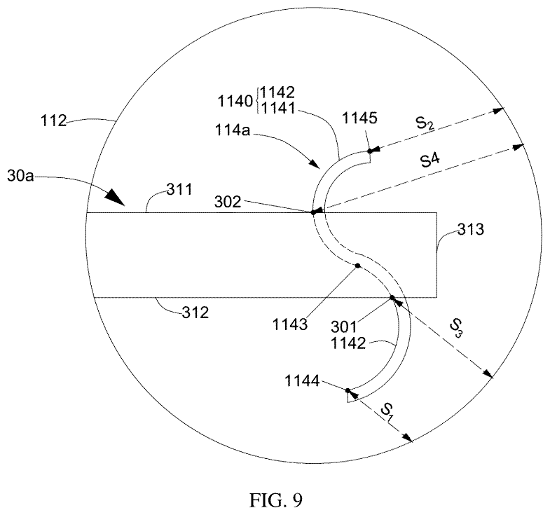

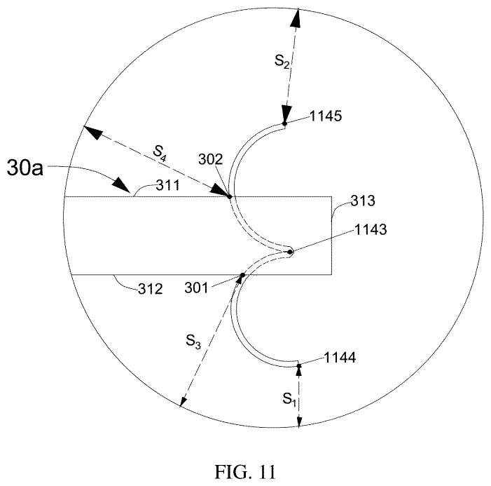

The at least two continuously connected curves are defined as a continuous curve 1140, the continuous curve 1140 is one continuous curve, and the continuous curve 1140 is divided into a plurality of continuously connected curves, with directions of two adjacent curves being the same or different. The continuous curve 1140 may include only two continuously connected curves, or may include three or more curves, and is specifically arranged according to needs. Based on the direction(s) of plurality of continuously connected curves of the continuous curve 1140, there are the following cases:
(1) If bending directions of two adjacent curves in several continuously connected curves are different from each other, the bending directions may be determined based on a quantity of direction changes of the plurality of continuously connected curves; if a quantity of direction changes of a plurality of continuously connected curves of the continuous curve 1140 is one, the continuous curve 1140 has two continuously connected curves; and if a quantity of direction changes of a plurality of continuously connected curves of the continuous curve 1140 is two, the continuous curve 1140 has three continuously connected curves, and so on. This will not be further elaborated herein. In this case, the connection point 1143 between the two adjacent curves is an inflection point. For example, as shown in FIG. 9, directions of a plurality of continuously connected curves of the continuous curve 1140 have changed once, meaning that the continuous curve 1140 is composed of two continuously connected curves in this case. As shown a first curve 1141 and a second curve 1142 in FIG. 9, a junction between the first curve 1141 and the second curve 1142 is the connection point 1143.
(2) If directions of several continuously connected curves are all the same, the continuous curve 1140 is observed from the same viewing angle and reference object. If the continuous curve 1140 has n recessed portions relative to the reference object, the continuous curve 1140 corresponds to n continuously connected curves, and in this case, the connection point between two adjacent curves is located at a position at which shapes of the two adjacent recessed portions abruptly change. FIG. 11 is used as an example. The continuous curve 1140 has two recessed portions relative to the third projection edge 313 (the third projection edge 313 is used as the reference object), the continuous curve 1140 is composed of two continuously connected curves in this case, and the shape of the continuous curve 1140 changes abruptly at the connection point 1143. Thus, it can be concluded that the junction of the two curves is located at the connection point 1143.
(3) If the continuous curve 1140 includes portions with the same directions and portions with different directions, continuous and different-direction portions of the continuous curve 1140 may be classified into a first portion, curves in the continuous curve 1140 connected to the first portion and having the same directions are a second portion, specific quantities of curves and inflection points in the first portion are determined according to the method described in case (1) above, and specific quantities of curves and inflection points in the second portion are determined according to the method described in case (2) above. This will not be further elaborated herein. For example, to facilitate understanding of case (3), the shape of the continuous curve 1140 shown in FIG. 8 is used as an example. The continuous curve 1140 includes a first portion 1140a with opposite directions and a second portion 1140b connected to the first portion 1140a. In the first portion 1140a, directions of a plurality of connected curves are all different. In this case, it can be determined according to the situation in case (1) that the first portion 1140a is formed by connecting two curves, the direction of the second portion 1140b is the same as the direction of the connected curve. The second portion 1140b shown in FIG. 8 has only one curve, so it can be directly determined that the second portion 1140b has only one curve, meaning that the continuous curve 1140 in FIG. 8 is composed of three continuously connected curves. It can be understood that, if the second portion 1140b may extend to form a plurality of curves with the same directions, quantities of curves and connection points are determined according to case (2).

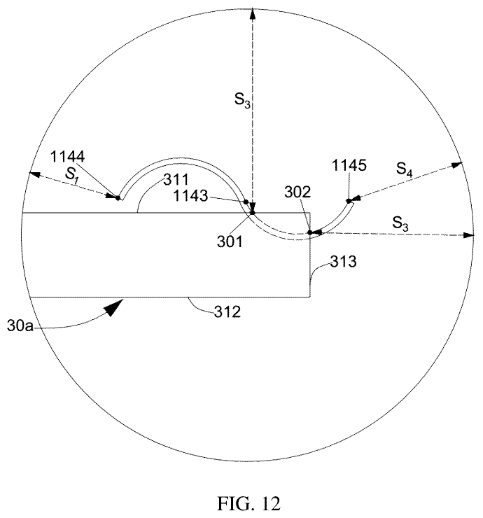

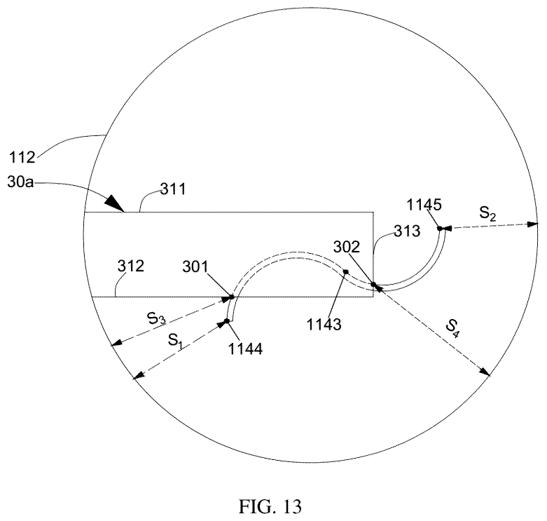

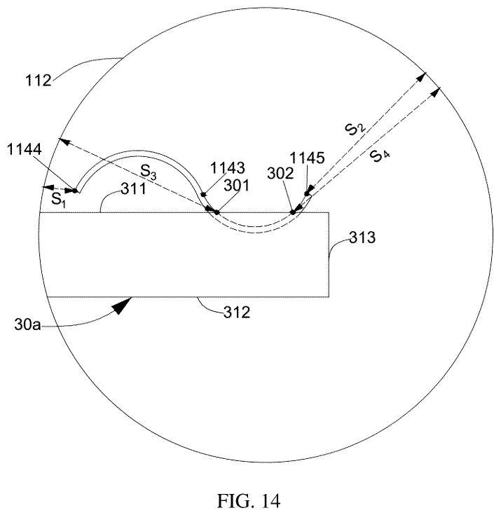

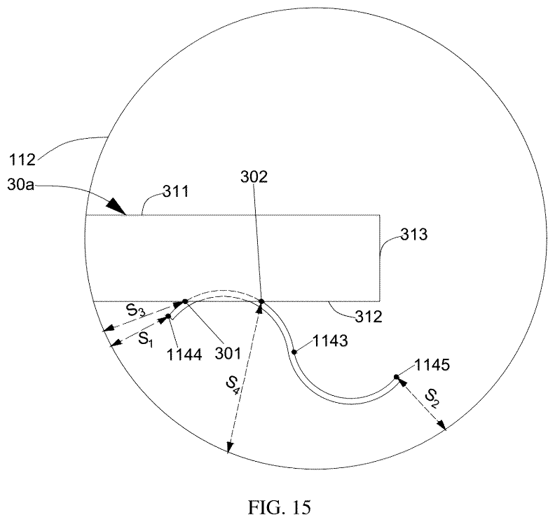

For example, q quantity of intersection points between a contour of the first projection 30a and the continuous curve 1140 is two, meaning that, in this case, projections of the groove 114 and the first electrode tab 30 on the first wall 112 in the first direction X have an overlapping portion. The overlapping situations of the first projection 30a and the continuous curve 1140 include but are not limited to the following: (1) As shown in FIGS. 6 to 11, the continuous curve 1140 passes through the first projection edge 311 and the second projection edge 312; (2) as shown in FIG. 12, the continuous curve 1140 passes through the first projection edge 311 and the third projection edge 313; (3) as shown in FIG. 13, the continuous curve 1140 passes through the second projection edge 312 and the third projection edge 313; (4) as shown in FIG. 14, the continuous curve 1140 only intersects with the first projection edge 311, meaning that the continuous curve 1140 enters from the first projection edge 311 and extends out of the first projection 30a from the first projection edge 311; and (5) as shown in FIG. 15, the continuous curve 1140 only intersects with the second projection edge 312, meaning that along an extending direction of the second projection 114a, the continuous curve 1140 enters from the second projection edge 312 and extends out of the first projection 30a from the second projection edge 312.

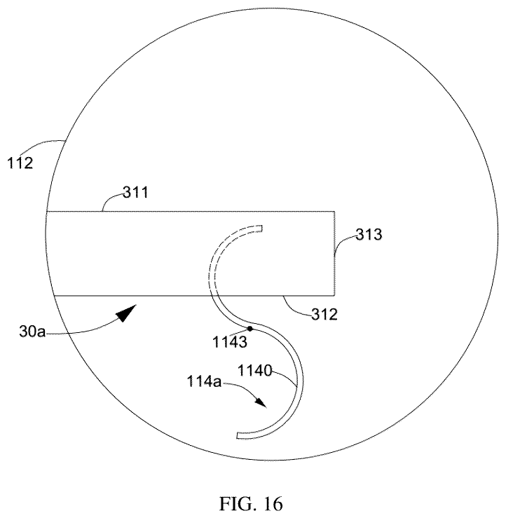

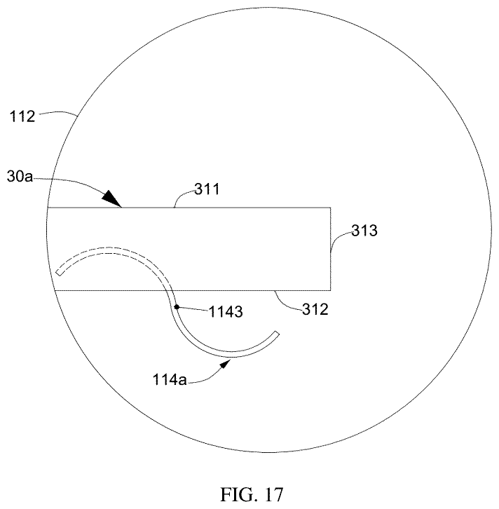

For example, as shown in FIG. 16 or FIG. 17, a quantity of intersection points between the contour of the first projection 30a and the continuous curve 1140 is one. A region occupied by the first projection 30a on a surface of the first wall 112 is defined as a first region, and a region on the surface of the first wall 112 other than the first region is defined as a second region. In this case, one end of the continuous curve 1140 is located in the second region, and the other end of the continuous curve 1140 extends into the first region from the first projection edge 311, the second projection edge 312, or the third projection edge 313.

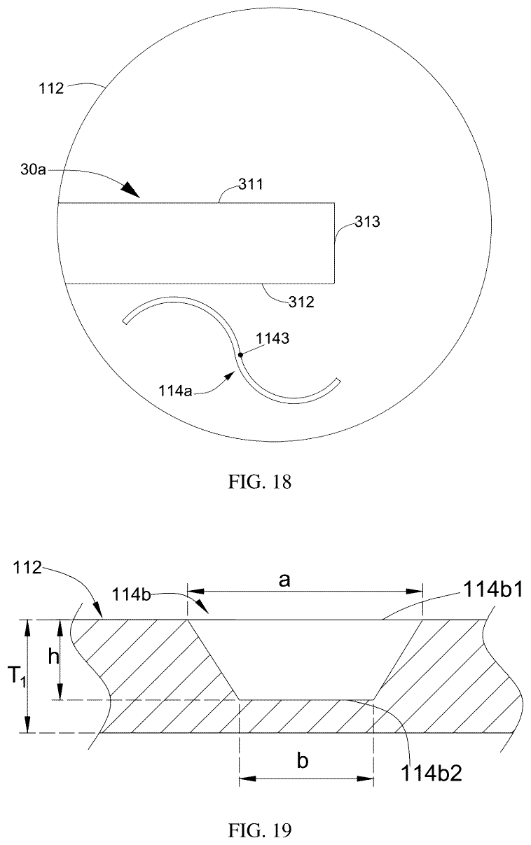

For example, as shown in FIG. 18, the contour of the first projection 30a has no intersection points with the continuous curve 1140. In this case, the first projection 30a and the second projection 114a have no overlapping portion on the first wall 112, and the first electrode tab 30 does not cover the groove 114.

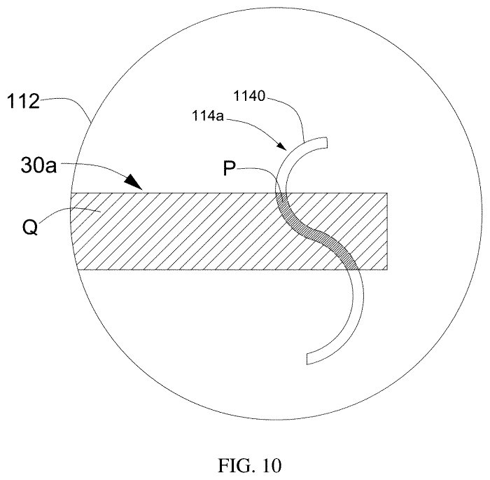

In some embodiments, referring to FIG. 10 again, an area of the first projection 30a is denoted as Q, and an overlapping area of the first projection 30a and the second projection 114a in the first direction X is denoted as P, where P≤Q/2. When this relationship is met, the risk of the gas generated in the accommodating cavity 101 being blocked by the first electrode tab 30 can be reduced, which is favorable for the gas to squeeze the groove 114 in a timely manner, and favorable for the gas in the accommodating cavity 101 to break through the groove 114 in a timely manner once the pressure required to break the groove 114 is reached, thereby improving the safety of the button cell 100.

In some embodiments, referring to FIG. 9 again, the continuous curve 1140 includes two continuously connected curves, namely, a first curve 1141 and a second curve 1142, and a junction between the first curve 1141 and the second curve 1142 is the connection point 1143. The two ends of the groove 114 are a third end 1144 and a fourth end 1145. The continuous curve 1140 is one edge of the groove 114, and therefore the two ends of the groove 114 are the two ends of the continuous curve 1140. The first projection 30a intersects with the continuous curve 1140 at a first intersection point 301 and a second intersection point 302, and the first intersection point 301 is closer to the third end 1144 than the second intersection point 302. In this case, a shortest distance from the third end 1144 to an edge of the first wall 112 is S₁, a shortest distance from the fourth end 1145 to an edge of the first wall 112 is S₂, a shortest distance from the first intersection point 301 to an edge of the first wall 112 is S₃, a shortest distance from the second intersection point 302 to an edge of the first wall 112 is S₄, where S₁<S₃, S₂<S₃, S₁<S₄, and S₂<S₄. When this relationship is met, the continuous curve 1140 passes through at least two projection edges of the first projection 30a, which may be the first projection edge 311 and the second projection edge 312, or may be the first projection edge 311 (or the second projection edge 312) and the third projection edge 313. Thus, in the first direction X, the second projection 114a has a portion not covered by the first projection 30a, indicating that the groove 114 is not completely covered by the first electrode tab 30, which is favorable for the gas in the accommodating cavity 101 to break through the groove 114 from the portion of the groove 114 not covered by the first electrode tab 30, and helps allow the button cell 100 to timely relieve pressure.

It can be understood that, the directions of the first curve 1141 and the second curve 1142 are the same, and the shapes thereof change at the connection point 1143, thereby increasing the stress concentration at the inflection point between the first curve 1141 and the second curve 1142, which helps improve the safety of the button cell 100.

It should be noted herein that S₁, S₂, S₃, and S₄ may be measured in the following steps: first scanning the button cell 100 with a CT (Computed Tomography) instrument, obtaining a metallographic image of the first electrode tab 30 overlapping the groove 114, based on the obtained metallographic image, taking several equidistant points on the edge contour of the first wall 112 at a preset interval, measuring distances from those several equidistant points to one measurement point, and then taking a minimum distance from the distances measured for the same measurement point as the minimum distance to the measurement point. For example, to measure the minimum distance from the first intersection point 301 to the first wall 112, the edge contour of the first wall 112 is divided into n equidistant points at a 3 mm interval, distances from these n equidistant points to the first intersection point 301 are measured, and a minimum distance from the measured distances is taken as the minimum distance from the first intersection point 301 to the edge of the first wall 112.

In some embodiments, viewed from the first direction X, at least one connection point 1143 is located outside the first projection 30a, which can reduce the risk of the connection point 1143 being completely covered by the first electrode tab 30, is favorable for the gas inside the button cell 100 to directly squeeze the connection point 1143, so as to achieve discharge of the internal pressure of the button cell 100 in a timely manner, thereby improving the safety of the button cell 100.

In some embodiments, in the first direction X, a thickness of the first wall 112 is T₁ μm, a depth of the groove 114 is h μm, where 0.2T₁≤h≤0.7T₁, and 30≤T₁≤300. In this way, the thickness of the first wall 112 in a region at which the groove 114 is located will become thinner compared to other regions of the first wall 112, and the region at which the groove 114 is located is easily deformed by the gas in the accommodating cavity, which is favorable for the gas in the accommodating cavity to break through the housing from the region at which the groove 114 is located, reduces the risk of excessive internal pressure due to gas accumulation in the button cell 100, and also reduces the impact of excessive thickness of the groove 114 on the strength of the housing 10, thereby improving the lifespan of the button cell 100. In addition the first wall 112 in the region in which the groove 114 is located is relatively weak, and during the transportation of the button cell 100, when the first wall 112 is subjected to vibration or slight impact, the risk of the groove 114 being broken through by external force and in turn causing the failure of the button cell 100 is reduced. The depth of the groove 114 is a maximum depth of the groove 114, and may be measured by obtaining a cross-sectional image of the first wall 112 and measuring the depth in the image; or may be measured by instruments in the first direction X.

In some embodiments, as shown in FIG. 19, in a direction perpendicular to the extending direction of the groove 114, the groove 114 has a first cross section 114b. The first cross section 114b has a first side 114b1 and a second side 114b2 arranged oppositely, and the first side 114b1 is closer to the accommodating cavity 101 than the second side 114b2. A size of the first side 114b1 is a μm, and a size of the second side 114b2 is b μm.

It can be understood that, a shape of the first cross section 114b may vary, for example, it may be trapezoidal, pentagonal, or other irregular polygons, provided that the foregoing size relationship can be met.

Furthermore, b<a, the shape of the first cross section 114b is trapezoidal, and the groove 114 is arranged on a side of the first wall 112 close to the accommodating cavity 101. Thus, an inner side wall of the groove 114 forms an inclined surface relative to the surface of the first wall 112, which is favorable for the gas in the accommodating cavity 101 to converge from the first side 114b1 toward the second side 114b2, to be specific, favorable for the gas in the accommodating cavity 101 to converge toward the groove 114, and also favorable for the gas in the accommodating cavity 101 to break through the groove 114, thereby reducing the risk of an explosion of the button cell 100.

The direction perpendicular to the first direction X is defined as a second direction Y. The shape of the housing 10 may be cylindrical. In this case, the first direction X is a height direction of the housing 10, and the second direction Y is a radial direction of the cylindrical housing 10. The first cross section 114b may be obtained by cutting the first housing 110 along the second direction Y passing through the groove 114. In some embodiments, the shape of the housing 10 may alternatively be non-cylindrical, for example, it may be a D-shaped column body with a cross-sectional contour of the housing 10 along the second direction Y, or of course may be other shapes. The shape of the housing 10 may be specifically designed according to actual needs.

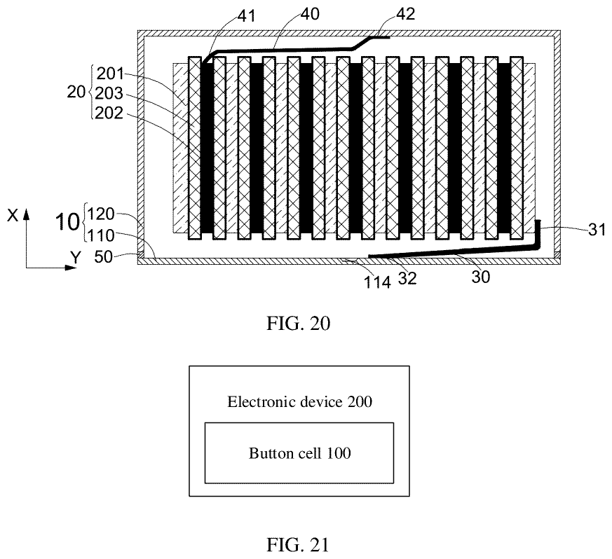

In some embodiments, the housing 10 is cylindrical, and the first housing 110 and the second housing 120 may be directly or indirectly connected to form the above-mentioned accommodating cavity 101. In one case, as shown in FIG. 20, when the first housing 110 is indirectly connected to the second housing 120, the button cell 100 further includes a second electrode tab 40 and an insulating member 50. The second electrode tab 40 includes a fifth end 41 and a sixth end 42, where the fifth end 41 and the sixth end 42 are two opposite ends of the second electrode tab 40. The insulating member 50 is arranged between the first housing 110 and the second housing 120, and the insulating member 50 is configured to insulate the first housing 110 from the second housing 120. The insulating member 50 may be installed on the first housing 110 or the second housing 120 through bonding or in other means. The second electrode tab 40 may be directly connected to an inner wall of the second housing 120, to be specific, the fifth end 41 is connected to the second electrode plate 202, and the sixth end 42 is connected to the second housing 120. The first wall 112 is arranged on the first housing 110, and the first wall 112 and the second housing 120 are oppositely arranged in the first direction X. Thus, under the insulating effect of the insulating member 50, the first housing 110 and the second housing 120 have different polarities. The insulating member 50 may include, but is not limited to, a gasket made of insulating material.

In another case, referring to FIG. 2 again, the first housing 110 and the second housing 120 may be directly connected through welding or threading, or in other means. The button cell 100 includes a second electrode tab 40, an insulating member 50, and a pole 60, where the insulating member 50 is configured to insulate the pole 60 from the housing 10. The housing 10 is provided with an opening 102, the insulating member 50 is installed in the opening 102 and sleeved on the pole 60, so that the pole 60 is clamped to the housing 10, and the pole 60 and the insulating member 50 fit to close the opening 102. The fifth end 41 of the second electrode tab 40 is connected to the second electrode plate 202, the sixth end 42 of the second electrode tab 40 is connected to the pole 60, and the housing 10 and the pole 60 have different polarities. The first wall 112 is arranged on the first housing 110, and the first wall 112 and the pole 60 are oppositely arranged in the first direction.

It can be understood that, the second housing 120 is a rotating body with an accommodating space. For example, the second housing 120 is in a regular cylindrical shape; the first housing 110 is in the shape of a flat plate, and the first housing 110 is connected to the second housing 120 to form the housing 10. The first wall 112 may be disposed on the first housing 110 or the second housing 120, and may be specifically arranged according to needs.

The button battery 100 provided in some embodiments of this application includes a housing 10, an electrode assembly 20, and a first electrode tab 30. The housing 10 is provided with an accommodating cavity 101. The housing 10 includes a first wall 112. The electrode assembly 20 and the first electrode tab 30 are both accommodated in the accommodating cavity 101. A first end 31 of the first electrode tab 30 is connected to the electrode assembly 20, and a second end 32 of the first electrode tab 30 is connected to the first wall 112. The housing 10 is provided with a groove 114. Viewed from a first direction X, the groove 114 includes at least two continuously connected curves, an orthogonal projection of the first electrode tab 30 on the first wall 112 is a first projection 30a, and an orthogonal projection of the groove 114 on the first wall 112 is a second projection 114a. At least a portion of the at least two continuously connected curves is located outside the first projection 30a, a quantity of intersection points between a contour of the first projection 30a and the at least two continuously connected curves is less than or equal to 2, and the first direction X is perpendicular to the first wall 112. With the above structure, the first wall 112 is thinner at the groove 114. When the internal pressure of the accommodating cavity 101 increases enough to break through the groove 114, the groove 114 is squeezed by the gas in the accommodating cavity 101 and broken through, allowing the gas inside the button cell 100 to be discharged in a timely manner, reducing the risk of an explosion due to excessive internal pressure in the button cell 100. In addition, the groove 114 of this application includes at least two continuously connected curves, the plurality of continuously connected curves can increase the stress concentration points at the groove 114 of the first wall 112, and the connection points between the plurality of continuously connected curves have obvious stress concentration, which is favorable for the gas in the accommodating cavity 101 to break through the groove 114, thereby improving the safety of the button cell 100.

As shown in FIG. 21, another embodiment of this application provides an electronic device 200, including the above-mentioned button cell 100, where the button cell 100 is configured to provide power to the electronic device 200.

In conclusion, it should be noted that the foregoing embodiments are merely intended to describe the technical solutions of this application, but not to limit this application. Under the concept of this application, the technical features in the foregoing embodiments or different embodiments can also be combined, the steps can be implemented in any order, and there are also many other variations in different aspects of this application as described above, which are not provided in detail for the sake of brevity. Although this application is described in detail with reference to the foregoing embodiments, persons of ordinary skill in the art should understand that modifications can be made to the technical solutions described in the foregoing embodiments, or equivalent substitutions can be made to some technical features therein, and these modifications or substitutions do not make the essence of the corresponding technical solutions depart from the scope of the technical solutions of some embodiments of this application.

What is claimed is:

1. A button cell, comprising a housing, an electrode assembly, and a first electrode tab, wherein the housing is provided with an accommodating cavity; the electrode assembly and the first electrode tab are both accommodated in the accommodating cavity; and the housing comprises a first wall, the first electrode tab comprising a first end and a second end arranged oppositely along an extending direction of the first electrode tab, the first end being connected to the electrode assembly, and the second end being connected to the first wall; wherein,
the housing is provided with a groove, wherein viewed from a first direction, the groove comprises at least two continuously connected curve shaped sub-grooves;
an orthogonal projection of the first electrode tab on the first wall is a first projection;
at least a portion of the groove is located outside the first projection;
the groove intersects with a contour of the first projection less than or equal to 2 times; and
the first direction is perpendicular to the first wall.

2. The button cell according to claim 1, wherein,
an orthogonal projection of the groove on the first wall is a second projection; wherein,
an overlapping area of the first projection and the second projection is P;
an area of the first projection is Q; and
P≤Q/2.

3. The button cell according to claim 1, wherein,
viewed from the first direction, a junction between two adjacent curve shaped sub-grooves is a connection point; and
at least one of the connection points is located outside the first projection.

4. The button cell according to claim 1, wherein,
the groove is composed of two continuously connected curve shaped sub-grooves;
two opposite ends of the groove along an extending direction of the two continuously connected curve shaped sub-grooves are a third end and a fourth end;
the groove intersects with the first projection at a first intersection point and a second intersection point; wherein,
the first intersection point is located between the third end and the second intersection point;
a shortest distance from the third end to an edge of the first wall is S₁;
a shortest distance from the fourth end to the edge of the first wall is S₂;
a shortest distance from the first intersection point to the edge of the first wall is S₃;
a shortest distance from the second intersection point to the edge of the first wall is S₄; wherein,
S₁<S₃;
S₂<S₃;
S₁<S₄; and
S₂<S₄.

5. The button cell according to claim 1, wherein,
in the first direction, a thickness of the first wall is T₁ μm;
in the first direction, a depth of the groove is h μm; wherein,
0.2T₁≤h≤0.7T₁; and
30≤T₁≤300.

6. The button cell according to claim 1, wherein,
in a direction perpendicular to an extending direction of the groove, the groove has a first cross section;
a shape of the first cross section is trapezoidal;
in the first direction, the first cross section has a first side and a second side arranged opposite to each other;
the first side being closer to the accommodating cavity than the second side from the accommodating cavity; and
a size of the first side is larger than a size of the second side.

7. The button cell according to claim 1, wherein,
the button cell further comprises a pole, an insulating member, and a second electrode tab; wherein,
the housing is provided with an opening;
the pole and the insulating member are disposed at the opening;
the pole and the insulating member fit to close the opening;
the insulating member is configured to insulate the pole from the housing;
the second electrode tab comprises a fifth end and a sixth end arranged oppositely along an extending direction of the second electrode tab;
the fifth end being connected to the electrode assembly;
the sixth end being connected to the pole; and
the first wall and the pole are oppositely arranged in the first direction.

8. The button cell according to claim 1, wherein,
the button cell further comprises an insulating member and a second electrode tab; wherein,
the housing comprises a first housing and a second housing;
the first housing is connected to the second housing;
the first housing and the second housing jointly enclose the accommodating cavity;
the insulating member is disposed between the first housing and the second housing;
the insulating member is configured to insulate the first housing from the second housing;
the second electrode tab comprises a fifth end and a sixth end arranged oppositely along an extending direction of the second electrode tab;
the fifth end is connected to the electrode assembly;
the sixth end is connected to the second housing;
the first wall is disposed on the first housing; and
the first wall and the second housing are oppositely arranged in the first direction.

9. The button cell according to claim 1, wherein, directions of two adjacent curve shaped sub-grooves of the at least two continuously connected curve shaped sub-grooves are the same.

10. The button cell according to claim 1, wherein, the first electrode tab is welded to the first wall.

11. The button cell according to claim 1, wherein, a shape of the first wall is planar.

12. The button cell according to claim 1, wherein, the electrode assembly is a wound structure or a laminated structure.

13. An electronic device, comprising a button cell, the button cell comprises a housing, an electrode assembly, and a first electrode tab, wherein the housing is provided with an accommodating cavity; the electrode assembly and the first electrode tab are both accommodated in the accommodating cavity; and the housing comprises a first wall, the first electrode tab comprising a first end and a second end arranged oppositely along an extending direction of the first electrode tab, the first end being connected to the electrode assembly, and the second end being connected to the first wall; wherein,
the housing is provided with a groove, wherein viewed from a first direction, the groove comprises at least two continuously connected curve shaped sub-grooves;
an orthogonal projection of the first electrode tab on the first wall is a first projection;
at least a portion of the groove is located outside the first projection;
the groove intersects with a contour of the first projection less than or equal to 2 times; and
the first direction is perpendicular to the first wall.

14. The electronic device according to claim 13, wherein,
an orthogonal projection of the groove on the first wall is a second projection; wherein,
an overlapping area of the first projection and the second projection is P;
an area of the first projection is Q; and
P≤Q/2.

15. The electronic device according to claim 13, wherein,
viewed from the first direction, a junction between two adjacent curve shaped sub-grooves is a connection point; and
at least one of the connection points is located outside the first projection.

16. The electronic device according to claim 13, wherein,
the groove is composed of two continuously connected curve shaped sub-grooves;
two opposite ends of the groove along an extending direction of the two continuously connected curve shaped sub-grooves are a third end and a fourth end;
the groove intersects with the first projection at a first intersection point and a second intersection point; wherein,
the first intersection point is located between the third end than the second intersection point;
a shortest distance from the third end to an edge of the first wall is S₁;
a shortest distance from the fourth end to the edge of the first wall is S₂;
a shortest distance from the first intersection point to the edge of the first wall is S₃;
a shortest distance from the second intersection point to the edge of the first wall is S₄; wherein,
S₁<S₃;
S₂<S₃;
S₁<S₄; and
S₂<S₄.

17. The electronic device according to claim 13, wherein,
in the first direction, a thickness of the first wall is T₁ μm;
in the first direction, a depth of the groove is h μm; wherein,
0.2T₁≤h≤0.7T₁; and
30≤T₁≤300.

18. The electronic device according to claim 13, wherein,
in a direction perpendicular to an extending direction of the groove, the groove has a first cross section;
a shape of the first cross section is trapezoidal;
in the first direction, the first cross section has a first side and a second side arranged opposite to each other;
the first side being closer to the accommodating cavity than the second side from the accommodating cavity; and
a size of the first side is larger than a size of the second side.

19. The electronic device according to claim 13, wherein,
the button cell further comprises a pole, an insulating member, and a second electrode tab; wherein,
the housing is provided with an opening;
the pole and the insulating member are disposed at the opening;
the pole and the insulating member fit to close the opening;
the insulating member is configured to insulate the pole from the housing;
the second electrode tab comprises a fifth end and a sixth end arranged oppositely along an extending direction of the second electrode tab;
the fifth end being connected to the electrode assembly;
the sixth end being connected to the pole; and
the first wall and the pole are oppositely arranged in the first direction.

20. The electronic device according to claim 13, wherein,
the button cell further comprises an insulating member and a second electrode tab; wherein,
the housing comprises a first housing and a second housing;
the first housing is connected to the second housing;
the first housing and the second housing jointly enclose the accommodating cavity;
the insulating member is disposed between the first housing and the second housing;
the insulating member is configured to insulate the first housing from the second housing;
the second electrode tab comprises a fifth end and a sixth end arranged oppositely along an extending direction of the second electrode tab;
the fifth end is connected to the electrode assembly;
the sixth end is connected to the second housing;
the first wall is disposed on the first housing; and
the first wall and the second housing are oppositely arranged in the first direction.
